(19) United States
(12) Patent Application Publication
(10) Pub. No.: US 2021/0347703 A1
(43) Pub. Date: Nov. 11, 2021

(54) MANUFACTURE OF FERTILISER

(71) Applicants: Jacobus Johannes VAN DER MERWE, Whakatane (NZ); Jakub Bogdan SKUT, Mount Maunganui (NZ); Michael James CORBETT, Mount Maunganui (NZ); BALLANCE AGRI-NUTRIENTS LIMITED, Mount Maunganui (NZ)

(72) Inventors: Jacobus Johannes VAN DER MERWE, Whakatane (NZ); Jakub Bogdan SKUT, Mount Maunganui (NZ); Michael James CORBETT, Mount Maunganui (NZ)

(21) Appl. No.: 17/282,848

(22) PCT Filed: Oct. 7, 2019
(86) PCT No.: PCT/NZ2019/050132

§ 371 Date: Apr. 5, 2021

(30) Foreign Application Priority Data
Oct. 5, 2018 (NZ) 747034
Aug. 21, 2019 (NZ) 756572

(51) Int. Cl. C05B 1/02; C05B 19/02

(52) U.S. Cl. CPC C05B 1/02; C05B 19/02

(57) ABSTRACT

Provided is a method of manufacturing phosphate fertilizer that comprises dicalcium phosphate, the method comprising providing milled phosphorus-containing rock having a total phosphorus content of at least about 15% P by weight, mixing the milled phosphate-containing rock with a mineral acid in a reaction vessel to produce a superphosphate product, and mixing the superphosphate product with a calcium-source reverting agent and a magnesium-source reverting agent to produce a reverted product, the calcium-source reverting agent comprising at least about 20% by weight of the total reverting agent of calcium oxide with a calcium carbonate equivalence of at least about 134%, and the magnesium-source reverting agent providing a magnesium source and comprising at least about 20% by weight of the total reverting agent of magnesium source with a calcium carbonate equivalence of at least about 80%, to produce a granulated cured reverted product having a product yield of at least about 1.90 or of at least about 1.77, and a moisture content of less than 3%.

### FIELD OF THE INVENTION

The present invention relates to a method of manufacturing a fertiliser comprising dicalcium phosphate.

### BACKGROUND TO THE INVENTION

To maintain a high level of animal and crop production, land usually requires supplementation with phosphate.

The phosphate containing components of the superphosphate fertilizers (including subgroup of reverted superphosphates) are: calcium dihydrogen phosphate Ca(H₂PO₄)₂ called monocalcium phosphate (MCP, found as monohydrate); calcium hydrogen phosphate CaHPO₄ called dicalcium phosphate (DCP), found as anhydrous i.e. monetite or dihydrate i.e. brushite); Fluorapatite Ca₁₀F₂(PO₄)₆ which is the most common apatite mineral (F⁻ in fluorapatite may be replaced by OH⁻ and Cl⁻; PO₄³⁻ by CO₃²⁻, SO₄²⁻, CrO₄²⁻ and SiO₂⁴⁻; and Ca²⁺ by Na⁺, K⁺, Mg²⁺ and heavy metals); metal phosphates (most commonly complex salts of CaFe₂(HPO₄)₄.nH₂O and CaAl₂(HPO₄).nH₂O; (Fe,Al)CaH(PO₄)₂.nH₂O may also be present). These differ in their solubility and hence the plant availability of the P. MCP, the major phosphorus containing component of single superphosphate (SSP) and triple superphosphate (TSP) readily dissolves in water which means that it can enter waterways as a result of leaching and loss during heavy rainfall event.

However, the DCP form has lower risk of P loss as DCP is not water soluble. Additionally, DCP is soluble in citric acid which means it is plant-available. The plant-availability of phosphate fertilisers in soil has been traditionally measured through solubility in 2% weight by volume citric acid as that mimics conditions in actual soil solution.

In general, superphosphate fertilizers are produced by treating phosphate rock with a mineral acid to give MCP.

SSP is produced by acidulation of finely ground phosphate rock with sulphuric acid. This process converts insoluble phosphates into forms more readily available to plants. The acid is usually diluted before it is mixed with the rock or the water may be added separately to the mixer. Many plants cool the acid in heat exchangers before use. The fluid material from the mixer goes to a den where it solidifies. Solidification results from continued reaction and crystallization of MCP. The superphosphate is cut from the den and conveyed to storage piles for final curing, which requires usually 2-6 weeks, depending on the nature and proportions of the raw materials and the conditions of manufacture. During curing the reaction approaches completion. If granular product is desired the product is granulated either before or after it is cured.

Single superphosphate contains up to 50% calcium sulphate (CaSO₄). If sulphuric acid is replaced by phosphoric acid for acidulation of phosphate rock, triple superphosphate (TSP) is produced with a higher content of MCP and without CaSO₄. Triple superphosphate is produced either by use of run-of-pile powder as an intermediate or by a direct slurry granulation process. The same equipment is used as for SSP production. However, the mixing time is shorter, due to faster chemical reaction (10-20 s). The reaction heat is one-third that for single superphosphate. The same temperature (80-100° C.) is reached, but less water vapour and silicon tetrafluoride (SiF₄) are evolved.

Various methods for making DCP have been reported. For example, U.S. Pat. No. 7,731,775 reports a four stage process that begins with reacting sulphuric acid with dolomitic phosphate ore to form MCP and calcium sulphate dihydrate CaSO₄.2H₂O (gypsum). Dolomitic phosphatic clay slime is then mixed with micronutrients and heated. The water in the slime disproportionates the MCP to brushite (dihydrate form of DCP: CaHPO₄.2H₂O) and phosphoric acid H₃PO₄. The H₃PO₄ dissolves additional phosphate ore, and reacts with the dolomitic phosphatic clay slime binding the soluble micronutrients to the clay platelets. In addition, the H₃PO₄ reacts with aluminum at the periphery of the clay platelets linking them together. Enough finely divided dolomitic phosphate ore is added then to partially neutralize the H₃PO₄ and bring the pH to about 3-6. Finally, KCl and urea are added to form a mixture which is then granulated and dried to form a fertiliser comprising DCP among other components.

It is an object of the present invention to provide a method of manufacturing stabilised phosphate fertiliser with DCP, to overcome any of the above-mentioned disadvantages, or to at least provide the public with a useful choice.

### SUMMARY OF THE INVENTION

In a first aspect the invention relates to a method of manufacturing phosphate fertiliser that comprises dicalcium phosphate comprising
providing milled phosphorus-containing rock having a total phosphorus content of at least about 15% P by weight,
mixing the milled phosphate-containing rock with a mineral acid in a reaction vessel to produce a superphosphate product, and
mixing the superphosphate product with a calcium-source reverting agent and a magnesium-source reverting agent to produce a reverted product, the calcium-source reverting agent comprising at least about 20% by weight of the total reverting agent of calcium oxide with a calcium carbonate equivalence of at least about 134%, and the magnesium-source reverting agent providing a magnesium source and comprising at least about 20% by weight of the total reverting agent of magnesium source with a calcium carbonate equivalence of at least about 80%, to produce a granulated cured reverted product having a product yield of at least about 1.90.

In a further aspect the invention relates to a method of manufacturing phosphate fertiliser that comprises dicalcium phosphate comprising
providing milled phosphorus-containing rock having a total phosphorus content of at least about 14.2% P by weight,
mixing the milled phosphate-containing rock with a mineral acid in a reaction vessel to produce a superphosphate product, and
mixing the superphosphate product with a calcium-source reverting agent and a magnesium-source reverting agent to produce a reverted product, the calcium-source reverting agent comprising at least about 25% by weight of calcium oxide with a calcium carbonate equivalence of at least about 134%, and the magnesium-source reverting agent providing a magnesium source and comprising at least about 25% by weight of magnesium source with a calcium carbonate equivalence of at least about 80%, to produce a granulated cured reverted product having a product yield of at least about 1.77 and a moisture content of less than 3%.

In a further aspect the invention relates to a method of manufacturing phosphate fertiliser comprising dicalcium phosphate comprising
providing milled phosphate-containing rock,
mixing the milled phosphate-containing rock with a mineral acid in a reaction vessel to produce a superphosphate product, and
mixing the superphosphate product with a calcium-source reverting agent and a magnesium-source reverting agent to produce a reverted product, the calcium-source reverting agent comprising at least about 25% by weight of calcium oxide with a calcium carbonate equivalence of at least about 134%, and the magnesium-source reverting agent providing a magnesium source and comprising at least about 25% by weight of magnesium source with a calcium carbonate equivalence of at least about 80%, to produce a granulated cured reverted product having a total phosphorus content of at least about 7.5% P by weight.

In a first aspect the invention relates to a method of manufacturing phosphate fertiliser that comprises dicalcium phosphate comprising
providing milled phosphorus-containing rock having a total phosphorus content of at least about 15% P by weight,
mixing the milled phosphate-containing rock with a mineral acid in a reaction vessel to produce a superphosphate product, and
mixing the superphosphate product with a calcium-source reverting agent and a magnesium-source reverting agent to produce a reverted product, the calcium-source reverting agent comprising at least about 20% by weight of the total reverting agent of calcium oxide with a calcium carbonate equivalence of at least about 134%, and the magnesium-source reverting agent providing a magnesium source and comprising at least about 50% by weight of the total reverting agent of magnesium source with a calcium carbonate equivalence of at least about 80%, to produce a granulated cured reverted product having a product yield of at least about 1.90.

In a further aspect the invention relates to a method of manufacturing phosphate fertiliser that comprises dicalcium phosphate comprising
providing milled phosphorus-containing rock having a total phosphorus content of at least about 14.2% P by weight,
mixing the milled phosphate-containing rock with a mineral acid in a reaction vessel to produce a superphosphate product, and
mixing the superphosphate product with a calcium-source reverting agent and a magnesium-source reverting agent to produce a reverted product, the calcium-source reverting agent comprising at least about 25% by weight of calcium oxide with a calcium carbonate equivalence of at least about 134%, and the magnesium-source reverting agent providing a magnesium source and comprising at least about 50% by weight of magnesium source with a calcium carbonate equivalence of at least about 80%, to produce a granulated cured reverted product having a product yield of at least about 1.77 and a moisture content of less than 3%.

Any one or more of the following embodiments may relate to any of the aspects described herein or any combination thereof.

Preferably the milled phosphorus-containing rock has a total phosphorus content of at least about 15.2% P by weight

Preferably the superphosphate is mixed with the reverting agents for 20, 30, 40, 50, 60, 70, 80, 90, 100, 110 or 120 seconds, and suitable ranges may be selected from between any of these values.

Preferably the reverted product is granulated and cured to produce a granulated cured reverted product.

Preferably the calcium-source reverting agent is selected from calcium oxide, or calcium hydroxide, or a combination thereof.

Preferably the second reverting agent (magnesium source) is selected from magnesium silicate rocks or magnesium oxide, or a combination thereof.

Preferably the magnesium silicate rock is selected from dunite or serpentine rock or a combination thereof.

Preferably the product yield is between about 1.77 to about 1.96, and suitable ranges may be selected from between any of these values.

Preferably the weight ratio of magnesium-source reverting agent to calcium-source reverting agent is between about 20:80 to about 80:20, and suitable ranges may be selected from between any of these values.

In one embodiment the weight ratio of magnesium-source reverting agent to calcium-source reverting agent is between about 80:20 to about 20:80, and suitable ranges may be selected from between any of these values.

In one embodiment the weight ratio of magnesium-source reverting agent to calcium-source reverting agent is between about 60:20 to about 50:50, and suitable ranges may be selected from between any of these values. More preferably the weight ratio of magnesium-source reverting agent to calcium-source reverting agent is between about 50:50 to about 60:30, and suitable ranges may be selected from between any of these values. In one embodiment the weight ratio of magnesium-source reverting agent to calcium-source reverting agent is about 60:30, 60:31, 60:32, 60:33, 60:34, 60:35, 60:36. 60:37, 60:38, 60:39, or 60:40, and suitable ranges may be selected from between any of these values.

Preferably the calcium-source reverting agent provides about 30% to about 50% by weight of the total weight of the reverting agents.

Preferably the calcium-source reverting agent is about 2.5, 3.0, 3.5, 4.0, 4.5, 5.0, 5.5, 6.0, 6.5, 7.0, 7.5, 8.0, 8.5, 9.0 or 9.5% by weight of the superphosphate-reverting agent mixture, and suitable ranges may be selected from between any of these values.

Preferably the magnesium-source reverting agent is about 2.5, 3.0, 3.5, 4.0, 4.5, 5.0, 5.5, 6.0, 6.5, 7.0, 7.5, 8.0, 8.5, 9.0 or 9.5% by weight of the superphosphate-reverting agent mixture, and suitable ranges may be selected from between any of these values. More preferably the magnesium-source reverting agent is about 4.0, 4.5, 5.0, 5.5, 6.0, 6.5, 7.0, 7.5, 8.0, 8.5 or 9% by weight of the superphosphate-reverting agent mixture, and suitable ranges may be selected from between any of these values.

Preferably the calcium-source reverting agent is about 2.5, 3.0, 3.5, 4.0, 4.5, 5.0, 5.5, 6.0, 6.5, 7.0, 7.5, 8.0, 8.5, 9.0 or 9.5% by weight of the superphosphate-reverting agent mixture, and suitable ranges may be selected from between any of these values. More preferably the magnesium-source reverting agent is about 4.0, 4.5, 5.0, 5.5, 6.0, 6.5, 7.0, 7.5, 8.0, 8.5 or 9% by weight of the superphosphate-reverting agent mixture, and suitable ranges may be selected from between any of these values.

Preferably the reverting agent is about 9, 10, 11, 12, 13, 14, 15, or 16% by weight of the superphosphate-reverting agent mixture, and suitable ranges may be selected from between any of these values.

Preferably the calcium-source reverting agent provides about 20, 30, 40, 50, 60, 70 or 80% of the total weight of the reverting agents, and suitable ranges may be selected from between any of these values.

Preferably the magnesium-source reverting agent provides about 20, 30, 40, 50, 60, 70 or 80% of the total weight of the reverting agents, and suitable ranges may be selected from between any of these values.

In one embodiment the superphosphate-reverting mixture comprises 0.5, 0.6, 0.7, 0.8, 0.9, 1.0, 1.1, 1.2, 1.3, 1.4, 1.5, 1.6, 1.7, 1.8 or 1.9% by weight elemental magnesium, and suitable ranges may be selected from between any of these values.

Preferably the mixing of the single superphosphate product and reverting agents is carried out in a mixer at a temperature of less than about 100° C.

Preferably the reverted product has a molar ratio of available calcium (aCa) to total phosphorus (tP) of about 0.93, 0.94, 0.95, 0.96, 0.97, 0.98, 0.99, 1.00, 1.01, 1.02, 1.03, 1.04 or 1.05, 1.06, 1.07, 1.08, 1.09, 1.10 and suitable ranges may be selected from between any of these values.

Preferably the reverted product has a pH of about 3.0, 3.5, 4.0, 4.5 or 5.0, and suitable ranges may be selected from between any of these values.

Preferably the reverted product has a total phosphorus content of at least about 7.5, 7.6, 7.7, 7.8, 7.9, 8.0, 8.1, 8.2, 8.3, 8.4 or 8.5% P by weight, and suitable ranges may be selected from between any of these values.

Preferably the granulation process is carried out at a temperature of less than about 100° C.

Preferably the granulated cured reverted product has a total phosphorus content of at least about 7.5, 7.6, 7.7, 7.8, 7.9, 8.0, 8.1, 8.2, 8.3, 8.4 or 8.5% P by weight, and suitable ranges may be selected from between any of these values.

Preferably at least about 70% of the total phosphorus in granulated cured reverted product is soluble in 2% weight by volume citric acid.

Preferably less than about 20, 21, 22, 23, 24 or 25% of the total phosphorus in the granulated cured reverted product is soluble in water, and suitable ranges may be selected from between any of these values.

Preferably the granulated cured reverted product has a pH of about 4.4, 4.5, 4.6, 4.7, 4.8, 4.9, 5.0, 5.1, 5.2, 5.3, 5.4, 5.5, 5.6 5.7, 5.8, 5.9 or 6.0, and suitable ranges may be selected from between any of these values.

Preferably the granulated cured reverted product has a moisture content of about 3, 4, 5, 6, 7, 8, 9, or 10% H₂O by weight, and suitable ranges may be selected from between any of these values.

Preferably the granulated cured reverted product has a calcium content of about 22.0, 22.5, 23.0, 23.5 or 24.0% Ca by weight, and suitable ranges may be selected from between any of these values.

Preferably the granulated cured reverted product has a sulphate sulphur content of about 9.8, 9.9, 10.0, 10.1, 10.2, 10.3, 10.4, 10.5, 10.6, 10.7, 10.8, 10.9, 11.0, 11.1, 1.2, 11.3, 11.4, 11.5, 11.6 or 11.7% S by weight, and suitable ranges may be selected from between any of these values.

Preferably the granulated cured reverted product has a magnesium content of at least about 0.9, 1.0, 1.1, 1.2, 1.3, 1.4, 1.5, 1.6, 1.7, 1.8, 1.9 or 2% Mg by weight.

Preferably the granulated cured reverted product has a granule strength of at least about 20, 21, 22, 23, 24 or 25 N, and suitable ranges may be selected from between any of these values.

Preferably the granulated cured reverted product has a granule degradation of less than about 10, 9, 8, 7, 6, 5, 4, 3, 2, or 1%, and suitable ranges may be selected from between any of these values.

Preferably the reverted product is cured on the pile to utilize higher temperatures which favour further reversion process from MCP to DCP.

Preferably the reverted product, or granulated cured reverted product, is cured for about 14 days.

Preferably during curing the reverted product cools from an initial temperature to a final ambient temperature.

Preferably the initial temperature of the reverted product is about 70, 75, 80, 85, 90, 95 or 100° C., and suitable ranges may be selected from between any of these values.

Preferably the cooling from an initial temperature to a final ambient temperature follows a cooling curve linearity that is characterised by a Pearson correlation coefficient of at least about −0.8.

Preferably a floor-based ventilation system is used to cool the reverted product from the initial temperature to the final ambient temperature.

Preferably the mineral acid is sulphuric acid.

In a further embodiment the invention relates to a fertiliser product as produced by the method described above.

In a further embodiment the invention relates to the use of a fertiliser product as produced by the method described above.

Unless otherwise stated, all values are given on an as wet basis.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

### BRIEF DESCRIPTION OF THE DRAWINGS

The invention will now be described by way of example only and with reference to the drawings in which:

FIG. 1 shows a traditional method to manufacture a fertiliser comprising DCP.

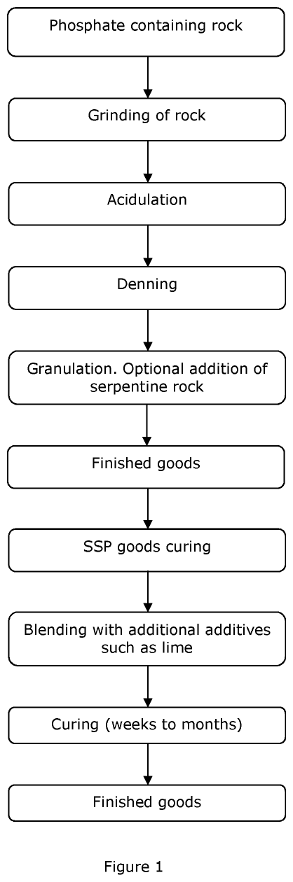

FIG. 2 shows the process of the present invention.

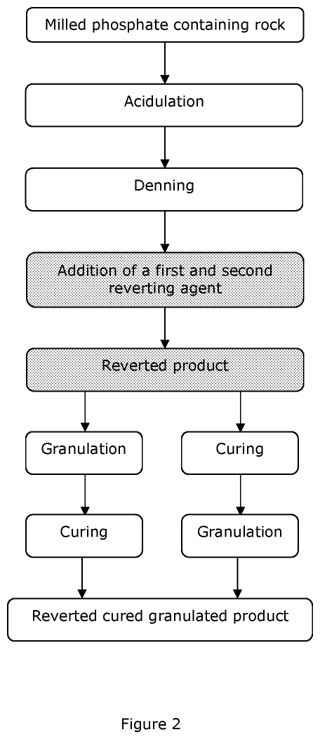

### DETAILED DESCRIPTION OF THE INVENTION

The present invention relates to a method of manufacturing fertiliser products with a process that does not require the extended cure times characteristic of current processes. The process provides milled phosphate-containing rock that is mixed with an acid to produce an acidified slurry. The acidified slurry is blended with serpentine rock and burnt lime, then granulated and cured to provide fertiliser comprising DCP having a total phosphorus content of at least 7.5-8.5% by weight.

### 1. PROCESS

### 1.1 Phosphate-Containing Ore

There are a range of phosphatic raw materials that can be used in conjunction with the present invention as a source of phosphate as described in the IFDC publication “World Phosphate Rock Reserves and Resources” by Steven J Van Kauwenbergh, dated September 2010 and incorporated herein by reference.

There are two main types of phosphate rock deposits: sedimentary and igneous. Phosphorite, phosphate rock or rock phosphate is a sedimentary rock that contains phosphate minerals although the content and grade of phosphate rock can vary from about 4% to about 20% expressed as P by weight. In some embodiments the phosphate rock contains about 15, 20, 25, 30, 35 or 40% expressed as P₂O₅ by weight, and suitable ranges may be selected from between any of these values. Igneous phosphate ores are often low in grade (less than 5% expressed as P₂O₅ by weight), but can be upgraded to high-grade products (from about 35 percent to over 40 percent expressed as P₂O₅ by weight.

Typical commercial sources of phosphate rocks are found in Morocco, Tunisia, Algeria, South Africa, China, Christmas Island and the states of Florida, Tennessee, Wyoming, Utah and Kansas in the United States.

Preferably the phosphate rock for use has a total phosphorus (TP) of at least 15.2, 15.3, 15.4, 15.5, 15.6, 15.7, 15.8, 15.9 or 16.0% P by weight, and suitable ranges may be selected from between any of these values, (for example, about 15.2 to about 15.9, about 15.2 to about 15.7, about 15.3 to about 16.0, about 15.3 to about 15.8, about 15.3 to about 15.5, about 15.4 to about 16.0, about 15.4 to about 15.8, about 15.4 to about 15.7, about 15.5 to about 16.0, about 15.5 to about 15.7, about 15.6 to about 16.0, about 15.6 to about 15.8 or about 15.7 to about 16.0% by weight).

In some embodiments the phosphate rock has a total phosphorus of at least 14.5% P by weight provided the moisture level in granulated cured reverted product is reduced to at least 3% H₂O by weight. In such an embodiment a dryer is used to reduce the moisture content to at least 3% H₂O by weight. Preferably the dryer is a rotary drum dryer.

In some embodiments the moisture level of the phosphate rock is about 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54 or 0.55% H₂O by weight, and suitable ranges may be selected from between any of these values, (for example, about 0.35 to about 0.55, about 0.35 to about 0.50, about 0.37 to about 0.55, about 0.37 to about 0.50, about 0.40 to about 0.55, about 0.40 to about 0.52, about 0.40 to about 0.50, about 0.42 to about 0.55, about 0.42 to about 0.50, about 0.43 to about 0.55, about 0.43 to about 0.51, about 0.43 to about 0.48, about 0.45 to about 0.55, about 0.45 to about 0.52 or about 0.45 to about 0.50% H₂O by weight).

Phosphorus is measured (based on the P level, as compared to phosphorus pentoxide) by the following method:
Phosphorus (as orthophosphate) for analysis is obtained by extracting the sample in boiling oxidising acid.
After filtration and dilution as required, an aliquot is reacted with acidified vanado-molydate reagent to produce a yellow coloured phosphovanadomolybdate complex.
The complex is analysed by spectrophotometry. The spectrophotometric method compares the amount of light, at a wavelength of 420 nm, absorbed by the developed colour relative to that absorbed by phosphorus standard solutions (see Fertmark Code of Practice, Appendix One, Industry Agreed Test Methods, section 2.7).

Preferably the phosphate rock for use has a molar ratio of total calcium (tCa) to total phosphorus (tP) i.e. tCa:tP of about 1.70, 1.71, 1.72, 1.73, 1.74, 1.75, 1.76, 1.77, 1.78, 1.79, 1.80, 1.81, 1.82, 1.83, 1.84 or 1.85, and suitable ranges may be selected from between any of these values, (for example, about 1.70 to about 1.85, about 1.70 to about 1.81, about 1.70 to about 1.77, about 1.70 to about 1.74, about 1.71 to about 1.85, about 1.71 to about 1.81, about 1.71 to about 1.79, about 1.71 to about 1.75, about 1.72 to about 7.52, about 1.72 to about 1.8, about 1.73 to about 1.85, about 1.73 to about 1.81, about 1.73 to about 1.79, about 1.74 to about 1.85, about 1.74 to about 1.81, about 1.74 to about 1.79, about 1.75 to about 1.85, about 1.75 to about 1.82, about 1.75 to about 1.79, about 1.76 to about 1.85, about 1.76 to about 1.83, about 1.76 to about 1.79, about 1.77 to about 1.85, about 1.77 to about 1.81, about 1.77 to about 1.79, about 1.78 to about 1.85 or about 1.78 to about 1.79).

Commonly the phosphate rock used is a blend of phosphate sources, such as different phosphate-containing rocks.

Preferably phosphate rock is milled such that at least 93% by weight passes through a 75 μm sieve.

### 1.2 Acidulation

The milled ore is mixed with a mineral acid. Preferably the mineral acid is selected from sulphuric acid or phosphoric acid, or any combination thereof. More preferably the acid is sulphuric acid.

Preferably the amount of acid that is added to the phosphate rock is sufficient to convert an apatite portion of the milled phosphate rock to phosphoric acid. In one embodiment the amount of acid to add is such that it leads to a molar ratio of available calcium (aCa) to total phosphorus (tP) i.e. aCa:tP of 0.45, 0.46, 0.47, 0.48, 0.49, 0.50, 0.51, 0.52, 0.53, 0.54, 0.55, 0.56, 0.57, 0.58, 0.59 or 0.60, and suitable ranges may be selected from between any of these values. These values closely correspond to the molar ratio of calcium to phosphorus i.e. Ca:P found in MCP molecular formula. If sulphuric acid is used as the mineral acid the majority of Ca from apatite contained in phosphate rock takes part in the reaction of the formation of the insoluble anhydrous CaSO₄. As the hydrolysis of anhydrous CaSO₄ is practically negligible, the available calcium is defined as any Ca²⁺ ions which directly reacts to form calcium phosphate salt (e.g. MCP, DCP).

Preferably the weight ratio of sulphuric acid (expressed as 100% H₂SO₄ by weight) to milled phosphate rock is 0.59, 0.60, 0.61, 0.62:1, 0.63:1, 0.64:1 or 0.65:1, 0.66:1, 0.67:1 and suitable ranges may be selected from between any of these values.

In one embodiment the milled phosphate rock is combined with sulphuric acid which is represented by the following simplified overall equation.

2Ca₅F(PO₄)₃+7H₂SO₄+3H₂O→7CaSO₄+3Ca(H₂PO₄)₂.H₂O+2HF

It has two consecutive stages:

Ca₅F(PO₄)₃+5H₂SO₄+3H₂O→5CaSO₄.½H₂O+3H₃PO₄.½H₂O+HF I

Ca₅F(PO₄)₃+7H₃PO₄+6H₂O→5Ca(H₂PO₄)₂.H₂O+H₂O+HF II

The acid (e.g. sulphuric acid) is preferably diluted with a mixture of water and hydrofluorosilicic acid (HFA) to achieve final concentration of about 65 to about 68% H₂SO₄ by weight.

When sulphuric acid is used, the sulphuric acid reacts with part of the milled phosphate rock forming phosphoric acid and calcium sulphate and the phosphoric acid produced further reacts with milled phosphate rock forming MCP.

The addition of sulphuric acid to the milled phosphate rock converts a portion thereof of the milled phosphate rock to phosphoric acid.

### 1.3 Denning

The mixture of milled phosphate-containing rock and the mineral acid is further reacted in a reaction vessel. The initial reaction slurry forms a SSP cake.

An example of a suitable vessel is a Broadfield Den, Moritz-Standaert den, Beskow den, Kuhlmann den and TVA mixer. A Broadfield den comprises a slowly moving floor that enables the reaction cake to form. The den has reciprocating sides, which prevent the reaction mixture from adhering to the walls. The partially matured mixture is then cut out of the den with a rotating cutter wheel.

Preferably the SSP (formed after the reaction vessel process) has a molar ratio of available calcium (aCa) to total phosphorus (tP) i.e. aCa:tP of 0.45, 0.46, 0.47, 0.48, 0.49, 0.50, 0.51, 0.52, 0.53, 0.54 or 0.55, 0.56, 0.57, 0.58, 0.59 or 0.60, and suitable ranges may be selected from between any of these values.

Preferably the SSP exiting the reaction vessel has a temperature of about 70, 71, 72, 73, 74, 75, 76, 77, 78, 79, 80, 81, 82, 83, 84 or 85° C., and suitable ranges may be selected from between any of these values.

Preferably the SSP exiting the reaction vessel has a total phosphorus level of about 8.4, 8.5, 8.6, 8.7, 8.8, 8.9, 9.0, 9.1 or 9.2% P by weight, and suitable ranges may be selected from between any of these values.

Preferably at least 85, 86, 87, 88, 89 or 90% of total phosphorus in the SSP exiting the reaction vessel is soluble in 2% weight by volume citric acid, and suitable ranges may be selected from between any of these values.

Preferably at least 78, 79, 80, 81, 82, 83, 84, 85, 86, 87, 88, 89 or 90% of total phosphorus in the SSP exiting the reaction vessel is soluble in water, and suitable ranges may be selected from between any of these values.

Preferably the SSP exiting the reaction vessel has a pH of about 1.8, 1.9, 2.0, 2.1, 2.2, 2.3 or 2.4, and suitable ranges may be selected from between any of these values.

Preferably the SSP exiting the reaction vessel has a moisture content of about 8, 9, 10, 11 or 12% H₂O by weight, and suitable ranges may be selected from between any of these values.

Preferably the SSP exiting the reaction vessel has a calcium content of about 19.0, 19.5, 20.0, 20.5, or 21.0 Ca by weight, and suitable ranges may be selected from between any of these values.

Preferably the SSP exiting the reaction vessel has a sulphate sulphur content of about 10.5, 10.6, 10.7, 10.8, 10.9, 11.0, 11.1, 11.2, 11.3, 11.4, 11.5, 11.6, 11.7, 11.8, 11.9 or 12% S by weight, and suitable ranges may be selected from between any of these values.

Preferably the SSP exiting the reaction vessel has a free phosphoric acid content of about 2.1, 2.2, 2.3, 2.4, 2.5, 2.6, 2.7, 2.8, 2.9, 3.0, 3.1, 3.2, 3.3, 3.4, 3.5, 3.6, 3.7 or 3.8 P by weight.

### 1.4 Reversion Process

The SSP is subsequently mixed with a reverting material that contains a calcium source (calcium-source reverting agent) and a reverting material that contains a magnesium source (magnesium-source reverting agent), to produce a reverted product. Without wishing to be limited by theory, the combination of calcium and magnesium liming materials utilises the maximum Calcium Carbonate Equivalent (CCE) of the calcium liming material and the magnesium liming material helps limit the molar ratio of available calcium (aCa) to total phosphorus (tP) i.e. aCa:tP while improving the CCE value. A benefit of the current invention is that it allows for neutralisation of the SSP product to a suitable pH range while maintaining the total phosphorus in the end-use product at a commercially useful amount. Furthermore, magnesium-source reverting agent provides Mg as an additional nutrient available for plant growth and improves granule strength of the granulated cured reverted product.

A measurement of a compounds liming ability is its calcium carbonate equivalence. The CCE is the standard by which a liming material is measured, and refers to the acid-neutralising capacity of a carbonate rock relative to that of pure calcium carbonate (e.g. calcite). The CCE is expressed as a percentage such that pure calcite has a value of 100%. Hence a liming material with a CCE greater than 100% indicates it has more liming capacity than pure calcium carbonate. Most limestones vary from these percentages to the presence of natural impurities, and also that most limestone is naturally a mixture of calcium sources, such as calcite and dolomite.

The calcium-source reverting agent has a calcium carbonate equivalence of at least 134, 135, 140, 145, 150, 155, 160, 165, 170, 175, or 179%, and suitable ranges may be selected from between any of these values, (for example, about 134 to about 179, about 134 to about 155, about 135 to about 179, about 135 to about 160, about 140 to about 179, about 140 to about 165, about 140 to about 150, about 145 to about 179, about 145 to about 175, about 145 to about 165, about 150 to about 179, about 150 to about 175, about 150 to about 165, about 155 to about 179, about 155 to about 165, about 160 to about 179%).

Preferably the calcium-source comprises high-purity calcium oxide. The calcium-source reverting agent comprises at least 75, 80, 85, 90, 95 or 100% by weight of calcium oxide, and suitable ranges may be selected from between any of these values. More preferably the calcium-source reverting agent comprises greater than 90% calcium oxide.

Preferably a suitable reverting material that contains a calcium source is calcium oxide or calcium hydroxide, or a combination thereof. However, it will be appreciated that any source of calcium having the aforementioned CCE value and calcium content would be suitable for use in the present invention.

The magnesium-source reverting agent has a calcium carbonate equivalence of at least 80, 85, 90, 95, 100, 105, 110, 115, 120, 125, 130, 135, 140, 145, 150, 155, 160, 165, 170, or 175%, and suitable ranges may be selected from between any of these values, (for example, about 80 to about 175, about 80 to about 160, about 80 to about 150, about 80 to about 125, about 85 to about 175, about 85 to about 165, about 85 to about 150, about 85 to about 130, about 90 to about 175, about 90 to about 170, about 90 to about 155, about 90 to about 145, about 95 to about 175, about 95 to about 155, about 95 to about 145, about 95 to about 120, about 100 to about 175, about 100 to about 165, about 100 to about 155, about 100 to about 130, about 105 to about 175, about 105 to about 155, about 110 to about 175, about 110 to about 165, about 110 to about 135, about 115 to about 175, about 115 to about 165, about 115 to about 155, about 120 to about 175, about 120 to about 155, about 120 to about 145, about 125 to about 175, about 125 to about 165, about 125 to about 160, about 130 to about 175, about 130 to about 160, about 130 to about 150, about 135 to about 175, about 135 to about 155, about 140 to about 175, about 140 to about 165, about 145 to about 175%).

The magnesium-source reverting agent comprises at least 15, 20, 25, 30, 35, 40, 45, 50 or 55% by weight of elemental magnesium, and suitable ranges may be selected from between any of these values. In one embodiment the magnesium-containing reverting source is free of calcium.

Preferably the magnesium-containing material is magnesium silicate rock. Preferably the magnesium-containing source is selected from serpentine rock, dunite, magnesium oxide, or a combination thereof. However, it will be appreciated that any source of magnesium having the aforementioned CCE value and magnesium content would be suitable for use in the present invention.

Table 1 below shows the typical liming values for a number of different materials.

TABLE 1
CCE values for a number of different materials

| Material | CCE |
|---|---|
| Burnt lime | Not less than 140% |
| Hydrated lime | Not less than 110% |
| Shells | Not less than 85% |
| Limestone | Not less than 85% |
| Industrial slag | Not less than 50% |

In one embodiment the reverting agents and the SSP are mixed in a mixer. An example of a suitable mixer is a pugmill mixer or ribbon mixer. It will be appreciated that any suitable mixer could be used that mix the SSP and reverting agents to product uniformity of chemical and physical characteristics. In particular, mixers that provide a kneading and folding over motion of the material being mixed. In one embodiment water is added to the mixer. Preferably the water is added to the conditioner in the mixer. The addition of water was determined by the inventors to allow the process to achieve high efficiency.

In some embodiments solids content accounts for about 94 to about 98% of the total loading of the mixer. In some embodiments the liquid accounts for about 4.5, 4.6, 4.7, 4.8, 4.9 or 5% of the total loading in the mixer.

Preferably the temperature in the mixer is less than about 95, 96, 97, 98, 99, 100° C., and suitable ranges may be selected from between any of these values.

In one embodiment the temperature of the mixer is maintained by the addition of a liquid to the mixer. Preferably the fluid is water. Preferably approximately 30, 32, 34, 36, 38, 40, 42, 44, 46, 48, 50, 52, 54, 56, 58 or 60% through the reversion process, and suitable ranges may be selected from between any of these values.

Preferably the water is added after the addition of the reverting agents.

The reversion process is represented by the following equations:

$${CaO}_{( s )} \to {Ca}_{( a q )}^{2 +} + {O}_{( a q )}^{2 -}$$

$${O}_{( aq )}^{2 -} + {H}_{2} {O}_{( l )} \to 2 {OH}_{( aq )}^{-}$$

$${CaO}_{( s )} + {H}_{2} {O}_{( l )} \to {Ca}_{( a q )}^{2 +} + 2 {OH}_{( a q )}^{-}$$

$${CaO}_{( s )} + {H}_{3} {PO}_{4 ( a q )} \to \underbrace{{CaHPO}_{4 ( s )}}_{Monetite} + {H}_{2} {O}_{( l )}$$

$${Ca ( {H}_{2} {PO}_{4} )}_{2} \cdot {H}_{2} {O}_{( s )} + {H}_{2} {O}_{( l )} \to \underbrace{{CaHPO}_{4 ( s )}}_{Monetite} + {H}_{3} {PO}_{4 ( a q )} + 2 {H}_{2} {O}_{( l )}$$

$${H}_{3} {PO}_{4 ( aq )} \to {H}_{( aq )}^{+} + {H}_{2} {PO}_{4 ( aq )}^{-}$$

$${Ca}_{( aq )}^{2 +} + {H}_{2} {PO}_{4 ( aq )}^{-} \to {CaHPO}_{4 ( s )} + {H}_{( aq )}^{+}$$

$${Mg}_{3} {Si}_{2} {{O}_{5} ( OH )}_{4 ( s )} + 6 {H}_{( aq )}^{+} \to 3 {Mg}_{( aq )}^{2 +} + 2 {H}_{4} {SiO}_{4 ( aq )} + {H}_{2} {O}_{( l )}$$

$${Mg}_{( aq )}^{2 +} + {H}_{2} {PO}_{4 aq )}^{-} \to {MgHPO}_{4 ( s )} + {H}_{( aq )}^{+}$$

Preferably the mixing acts to condition the mixture of SSP and the reverting agents. As used herein, “conditioning” refers to producing a temperature stable, evenly distributed blend. Preferably the mixing acts to agglomerate the mixture of SSP and reverting agents. As used herein, “agglomeration” means enlargement of fine powders into larger evenly distributed masses.

The calcium-source reverting agent is added to the mixer in dry form.

Most preferably the reverting agents (i.e. the calcium and magnesium—source reverting agents) are dry blended prior to addition into the mixer. Without wishing to be bound by theory, the dry blending of the materials into a uniform powder before addition into the mixture increases mixing efficiency with the SSP.

In an alternate embodiment the reverting agents are added to the SSP in a specific order selected from:
a) the calcium-source reverting agent followed by the magnesium-source reverting agent, or
b) the magnesium-source reverting agent followed by the calcium-source reverting agent.

In some embodiments the calcium-source reverting agent or magnesium-source reverting agent is first mixed with water to form a slurry before addition into the mixer.

In an alternate embodiment the reverting agents are added to the mixer in powder form.

In one embodiment the weight ratio of magnesium-source reverting agent to calcium-source reverting agent is between about 20:80 to about 40:60, and suitable ranges may be selected from between any of these values, (for example, about 20:80 to about 20:70, about 20:80 to about 20:60, about 20:80 to about 20:40, about 20:80 to about 20:35, about 20:70 to about 20:60, about 20:70 to about 20:40, about 20:70 to about 20:35, about 20:60 to about 20:40, about 20:60 to about 20:35, about 20:50 to about 20:40, about 20:50 to about 20:35, about 20:40 to about 20:35, and about 20:40 to about 20:30).

In some embodiments, the weight ratio of magnesium-source reverting agent to calcium-source reverting agent is between about 80:20 to about 20:80, and suitable ranges may be selected from between any of these values, (for example, about 80:20 to about 20:70, about 80:20 to about 20:60, about 80:20 to about 20:50, about 80:20 to about 20:40, about 80:20 to about 20:30, about 80:20 to about 20:20, about 80:20 to about 30:20, about 80:20 to about 40:20, about 80:20 to about 50:20, about 80:20 to about 60:20, about 70:20 to about 20:70, about 70:20 to about 20:60, about 70:20 to about 20:50, about 70:20 to about 20:40, about 70:20 to about 20:30, about 70:20 to about 20:20, about 70:20 to about 30:20, about 70:20 to about 40:20, about 70:20 to about 50:20, about 70:20 to about 60:20, about 60:20 to about 20:70, about 60:20 to about 20:60, about 60:20 to about 20:50, about 60:20 to about 20:40, about 60:20 to about 20:30, about 60:20 to about 20:20, about 60:20 to about 30:20, about 60:20 to about 40:20, about 60:20 to about 50:20, about 50:20 to about 20:70, about 50:20 to about 20:60, about 50:20 to about 20:50, about 50:20 to about 20:40, about 50:20 to about 20:30, about 50:20 to about 20:20, about 850:20 to about 30:20, about 50:20 to about 40:20, about 40:20 to about 20:70, about 40:20 to about 20:60, about 40:20 to about 20:50, about 40:20 to about 20:40, about 40:20 to about 20:30, about 40:20 to about 20:20, about 40:20 to about 30:20, about 30:20 to about 20:70, about 30:20 to about 20:60, about 30:20 to about 20:50, about 30:20 to about 20:40, about 30:20 to about 20:30, about 30:20 to about 20:20, about 20:20 to about 20:70, about 20:20 to about 20:60, about 20:20 to about 20:50, about 20:20 to about 20:40, about 20:20 to about 20:30).

In preferred embodiments, the weight ratio of magnesium-source reverting agent to calcium-source reverting agent is between about 60:20 to about 50:50, and suitable ranges may be selected from between any of these values. More preferably the weight ratio of magnesium-source reverting agent to calcium-source reverting agent is between about 50:50 to about 60:30, and suitable ranges may be selected from between any of these values. In one embodiment the weight ratio of magnesium-source reverting agent to calcium-source reverting agent is about 60:30, 60:31, 60:32, 60:33, 60:34, 60:35, 60:36. 60:37, 60:38, 60:39, or 60:40, and suitable ranges may be selected from between any of these values.

In one embodiment the calcium-source reverting agent provides about 20% to about 50% by weight of the total weight of the reverting agents, and suitable ranges may be selected from between any of these values.

Preferably the calcium-source reverting agent is about 2.5, 3.0, 3.5, 4.0, 4.5, 5.0, 5.5, 6.0, 6.5, 7.0, 7.5, 8.0, 8.5, 9.0 or 9.5% by weight of the superphosphate-reverting agent mixture, and suitable ranges may be selected from between any of these values, (for example, about 2.5 to about 9.5, about 2.5 to about 9.0, about 2.5 to about 7.5, about 2.5 to about 5.5, about 3.0 to about 9.5, about 3.0 to about 9.0, about 3.0 to about 7.5, about 3.5 to about 9.5, about 3.5 to about 6.5, about 4.0 to about 9.5, about 4.0 to about 5.5, about 4.5 to about 9.5, about 4.5 to about 8.5, about 4.5 to about 7.0, about 5.0 to about 9.5, about 5.0 to about 8.5, about 5.0 to about 7.0, about 5.5 to about 9.5, about 5.5 to about 9.0, about 5.5 to about 7.5, about 6.0 to about 9.5, about 6.0 to about 8.5, about 6.0 to about 7.0, about 6.5 to about 9.5 by weight of the superphosphate to about reverting agent mixture.

Preferably the magnesium-source reverting agent is about 2.5, 3.0, 3.5, 4.0, 4.5, 5.0, 5.5, 6.0, 6.5, 7.0, 7.5, 8.0, 8.5, 9.0 or 9.5% by weight of the superphosphate-reverting agent mixture, and suitable ranges may be selected from between any of these values. More preferably the magnesium-source reverting agent is about 4.0, 4.5, 5.0, 5.5, 6.0, 6.5, 7.0, 7.5, 8.0, 8.5 or 9% by weight of the superphosphate-reverting agent mixture, and suitable ranges may be selected from between any of these values, (for example, about 2.5 to about 9.5, about 2.5 to about 9.0, about 2.5 to about 7.5, about 2.5 to about 5.5, about 3.0 to about 9.5, about 3.0 to about 9.0, about 3.0 to about 7.5, about 3.5 to about 9.5, about 3.5 to about 6.5, about 4.0 to about 9.5, about 4.0 to about 5.5, about 4.5 to about 9.5, about 4.5 to about 8.5, about 4.5 to about 7.0, about 5.0 to about 9.5, about 5.0 to about 8.5, about 5.0 to about 7.0, about 5.5 to about 9.5, about 5.5 to about 9.0, about 5.5 to about 7.5, about 6.0 to about 9.5, about 6.0 to about 8.5, about 6.0 to about 7.0, about 6.5 to about 9.5 by weight of the superphosphate to about reverting agent mixture.

Preferably the calcium-source reverting agent is about 2.5, 3.0, 3.5, 4.0, 4.5, 5.0, 5.5, 6.0, 6.5, 7.0, 7.5, 8.0, 8.5, 9.0 or 9.5% by weight of the superphosphate-reverting agent mixture, and suitable ranges may be selected from between any of these values. More preferably the magnesium-source reverting agent is about 4.0, 4.5, 5.0, 5.5, 6.0, 6.5, 7.0, 7.5, 8.0, 8.5 or 9% by weight of the superphosphate-reverting agent mixture, and suitable ranges may be selected from between any of these values, (for example about 4.0 to about 9.0, about 4.0 to about 8.5, about 4.0 to about 7.0, about 4.5 to about 9.0, about 4.5 to about 8.5, about 4.5 to about 7.5, about 5.0 to about 9.0, about 5.0 to about 7.5, about 5.5 to about 9.0, about 5.5 to about 8.5, about 5.5 to about 7.0, about 6.0 to about 9.0, about 6.0 to about 8.0, about 6.5 to about 9.0, about 6.5 to about 8.5, about 6.5 to about 7.0, about 7.0 to about 9.5 by weight of the superphosphate to about reverting agent mixture).

Preferably the reverting agent is about 9, 10, 11, 12, 13, 14, 15, or 16% by weight of the superphosphate-reverting agent mixture, and suitable ranges may be selected from between any of these values, (for example, about 9 to about 16, about 9 to about 14, about 9 to about 12, about 10 to about 16, about 10 to about 15, about 10 to about 12, about 11 to about 16, about 11 to about 15, about 11 to about 14, about 12 to about 16, about 12 to about 15, about 12 to about 14, about 13 to about 16% by weight of the superphosphate to about reverting agent mixture).

Preferably the calcium-source reverting agent provides about 20, 30, 40, 50, 60, 70 or 80% of the total weight of the reverting agents, and suitable ranges may be selected from between any of these values, (for example about 20 to about 80, about 20 to about 70, about 20 to about 50, about 30 to about 80, about 30 to about 60, about 30 to about 50, about 30 to about 40, about 40 to about 80, about 40 to about 70, about 40 to about 60, about 50 to about 80, about 50 to about 70, about 50 to about 60, about 60 to about 80% of the total weight of the reverting agents).

In one embodiment the magnesium-source reverting agent provides about 20, 30, 40, 50, 60, 70 or 80% of the total weight of the reverting agents, and suitable ranges may be selected from between any of these values, (for example about 20 to about 80, about 20 to about 70, about 20 to about 50, about 30 to about 80, about 30 to about 60, about 40 to about 80, about 40 to about 70, about 40 to about 60, about 50 to about 80, about 50 to about 70, about 50 to about 60, about 60 to about 80% of the total weight of the reverting agents).

In one embodiment the superphosphate-reverting mixture comprises 0.5, 0.6, 0.7, 0.8, 0.9, 1.0, 1.1, 1.2, 1.3, 1.4, 1.5, 1.6, 1.7, 1.8 or 1.9% by weight elemental magnesium, and suitable ranges may be selected from between any of these values.

In one embodiment the amount of calcium-source reverting agent added is about 0.05, 0.06, 0.07, 0.08, or 0.09 kg per kg of SSP, and suitable ranges may be selected from between any of these values.

In one embodiment the amount of magnesium-source reverting agent added is about 0.03, 0.04, 0.05, 0.06, 0.07, 0.08, or 0.09 kg per kg of SSP, and suitable ranges may be selected from between any of these values.

Preferably the reverted product has a molar ratio of available calcium (aCa) to total phosphorus (tP) i.e. aCa:tP of about 0.90, 0.91, 0.92, 0.93, 0.94, 0.95, 0.96, 0.97, 0.98, 0.99, 1.00, 1.01, 1.02, 1.03, 1.04 or 1.05, 1.06, 1.07, 1.08, 1.09, 1.10 and suitable ranges may be selected from between any of these values.

Preferably the reverted product has a pH of about 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9 or 5.0, and suitable ranges may be selected from between any of these values, (for example, about 3.0 to about 5.0, about 3.0 to about 4.5, about 3.0 to about 4.1, about 3.0 to about 3.8, about 3.1 to about 5.0, about 3.1 to about 4.6, about 3.1 to about 4.2, about 3.1 to about 3.7, about 3.2 to about 5.0, about 3.2 to about 4.6, about 3.2 to about 4.1, about 3.2 to about 3.8, about 3.3 to about 5.0, about 3.3 to about 4.5, about 3.3 to about 4.1, about 3.3 to about 3.8, about 3.4 to about 5.0, about 3.4 to about 4.6, about 3.4 to about 4.2, about 3.4 to about 3.9, about 3.5 to about 5.0, about 3.5 to about 4.8, about 3.5 to about 4.4, about 3.5 to about 4.0, about 3.6 to about 5.0, about 3.6 to about 4.8, about 3.6 to about 4.2, about 3.7 to about 5.0, about 3.7 to about 4.8, about 3.7 to about 4.4, about 3.7 to about 4.1, about 3.8 to about 5.0, about 3.8 to about 4.7, about 3.8 to about 4.3, about 3.9 to about 5.0, about 3.9 to about 4.6, about 3.9 to about 4.2, about 4.0 to about 5.0, about 4.0 to about 4.7, about 4.0 to about 4.5, about 4.1 to about 5.0, about 4.1 to about 4.8, about 4.1 to about 4.6, about 4.2 to about 5.0, about 4.2 to about 4.8, about 4.2 to about 4.5, about 4.3 to about 5.0).

Preferably the reverted product has a total phosphorus content of at least about 7.5, 7.6, 7.7, 7.8, 7.9, 8.0, 8.1, 8.2, 8.3, 8.4 or 8.5% P by weight, and suitable ranges may be selected from between any of these values, (for example, about 7.5 to about 8.5, about 7.5 to about 8.1, about 7.6 to about 8.5, about 7.6 to about 8.3, about 7.6 to about 7.9, about 7.7 to about 8.5, about 7.7 to about 8.1, about 7.7 to about 7.9, about 7.8 to about 8.5, about 7.8 to about 8.3, about 7.8 to about 8.1, about 7.8 to about 8.5, or about 7.8 to about 8.3 P by weight).

The reverted product has a product yield of at least about 1.77, 1.79, 1.81, 1.83, 1.85, 1.87, 1.89, 1.91, 1.93, 1.95 or 1.96, and suitable ranges may be selected from between any of these values, (for example, about 1.77 to about 1.96, about 1.77 to about 1.91, about 1.77 to about 1.85, about 1.77 to about 1.81, about 1.79 to about 1.96, about 1.79 to about 1.93, about 1.79 to about 1.89, about 1.79 to about 1.83, about 1.81 to about 1.96, about 1.81 to about 1.91, about 1.81 to about 1.85, about 1.83 to about 1.96, about 1.83 to about 1.91, about 1.83 to about 1.87, about 1.85 to about 1.96, about 1.85 to about 1.93, about 1.85 to about 1.91, about 1.87 to about 1.96, about 1.87 to about 1.95, about 1.87 to about 1.91, about 1.89 to about 1.96, about 1.89 to about 1.93, about 1.91 to about 1.96, about 1.91 to about 1.93, or about 1.93 to about 1.96).

In some embodiments the superphosphate is mixed with the reverting agents for 20, 30, 40, 50, 60, 70, 80, 90, 100, 110 or 120 seconds, and suitable ranges may be selected from between any of these values, (for example, about 20 to about 120, 20 to about 100, 20 to about 8 to about, 20 to about 60, 30 to about 120, 30 to about 110, 30 to about 90, 30 to about 80, 30 to about 60, 40 to about 120, 40 to about 100, 40 to about 80, 40 to about 60, 50 to about 120, 50 to about 100, 50 to about 90, 50 to about 70, 60 to about 120, 60 to about 110, 60 to about 100, 60 to about 90, 60 to about 80, 70 to about 120, 70 to about 100, 80 to about 120, 80 to about 110, 80 to about 100, 90 to about 120 seconds).

Product yield is defined as the amount by weight of finished fertiliser product obtained from one part by weight of natural phosphate. The yield is calculated by the ratio of the P content in the phosphatic raw material and the total P content in superphosphate:

Product yield=P in phosphate rock/P in finished fertiliser product

### 1.5 Granulation and Curing Process

The reverted product is preferably subjected to curing and granulation (in no particular order).

The curing process is a continuation of the chemical reactions occurring during the reversion process. Additionally, brushite (DCP dihydrate) can be formed during the last step of curing when the temperature in the pile is reduced below at least about 40° C. and can be represented by the following equation:

$${Ca ( {H}_{2} {PO}_{4} )}_{2} \cdot {H}_{2} {O}_{( s )} + {H}_{2} {O}_{( l )} \to \underbrace{{CaHPO}_{4} \cdot 2 {H}_{2} {O}_{( s )}}_{Brushite} + {H}_{3} {PO}_{4 ( a q )}$$

In one embodiment the reverted product is cured for about 7, 8, 9, 10, 11, 12, 13 or 14 days to form a reverted product in ungranulated powder form. Subsequently the reverted product in ungranulated powder form is subjected to granulation to produce a granulated reverted product.

In an alternate embodiment the reverted product is first granulated prior to curing for about 7, 8, 9, 10, 11, 12, 13 or 14 days, to produce a granulated reverted product, and suitable ranges may be selected from between any of these values.

During curing the reverted product cools from an initial temperature to a final ambient temperature. In one embodiment the initial temperature of the reverted product is about 70, 75, 80, 85, 90, 95 or 100° C., and suitable ranges may be selected from between any of these values.

Preferably the cooling from an initial temperature to a final ambient temperature follows a cooling curve linearity that is characterised by a Pearson correlation coefficient of at least about −0.8.

Preferably a floor-based ventilation system is used to cool the reverted product from the initial temperature to the final ambient temperature.

Preferably the granulation is performed by a drum granulator.

Preferably the granulation process carried out at a temperature of less than about 100° C.

The granulated cured reverted product has a total phosphorus content of at least 7.5, 7.6, 7.7, 7.8, 7.9, 8.0, 8.1, 8.2, 8.3, 8.4 or 8.5% P by weight, and suitable ranges may be selected from between any of these values.

At least 70, 71, 72, 73, 74, 75, 76, 77, 78, 79 or 80% of the total phosphorus in granulated cured reverted product is soluble in 2% weight by volume citric acid, and suitable ranges may be selected from between any of these values.

Less than about 20, 21, 22, 23, 24 or 25% of the total phosphorus in the granulated cured reverted product is soluble in water, and suitable ranges may be selected from between any of these values.

The granulated cured reverted product has a pH of about 4.4, 4.5, 4.6, 4.7, 4.8, 4.9, 5.0, 5.1, 5.2, 5.3, 5.4, 5.5, 5.6 5.7, 5.8, 5.9 or 6.0, and suitable ranges may be selected from between any of these values.

The granulated cured reverted product has a moisture content of about 3, 4, 5, 6, 7, 8, 9, 10% H₂O by weight, and suitable ranges may be selected from between any of these values.

The granulated cured reverted product has a calcium content of about 22.0, 22.1, 22.2, 22.3, 22.4, 22.5, 22.6, 22.7, 22.8, 22.9, 23.0, 23.1, 23.2, 23.3, 23.4, 23.5, 23.6, 23.7, 23.8, 23.9 or 24.0% Ca by weight, and suitable ranges may be selected from between any of these values.

The granulated cured reverted product has a sulphate sulphur content of 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6 or 11.7% S by weight, and suitable ranges may be selected from between any of these values.

The granulated cured reverted product has a magnesium content of at least about 0.9% by weight.

The granulated cured reverted product has a granule strength of at least about 20, 21, 22, 23, 24 or 25 N, and suitable ranges may be selected from between any of these values.

Crushing strength is one of the parameters used to evaluate the physical quality of granulated fertilisers. This is important in the evaluation of the stability and subsequent spreading characteristics of fertilisers. This method is suitable for granulated fertiliser.

A measurable load is applied to individual fertiliser granules and the crushing point estimated (refer Fertmark Industry Agreed Methods February 2015 method 2.13). As described, when calculating the granule strength the particle size and shape of the granules are critical to obtaining a meaningful result. No agglomerates, chips or granules >3.35 mm should be tested. The testing process uses an Erweka strength tester having 4 mm & 3.35 mm sieves+pan.

The procedure is described as follows.
Sub sampling.
Riffle the sample and collect approximately 250 g.
Assemble the sieves 4 mm, 3.35 mm, pan and transfer the sample onto the 4 mm sieve and shake gently.
Collect the fraction retained on the 3.35 mm sieve and riffle this down further to collect about 50 granules.
Select 30 representative granules for testing.
Test the strength of the 30 granules using the Erweka strength tester.

The Erweka will produce a printout of individual granule strengths (in Newtons=kg×10), average, and standard deviation. The granule strength is reported to the nearest 0.1 kg and the standard deviation to the nearest 0.01 kg.

The granulated cured reverted product has a granule degradation of less than about 5, 6, 7, 8, 9 or 10%, and suitable ranges may be selected from between any of these values.

The ability of fertiliser to resist granule degradation is one of the parameters used to evaluate the physical quality of granulated fertilisers. Along with crushing strength, granule degradation resistance is important in the evaluation of the stability and subsequent spreading characteristics of fertilisers.

This method as described below for measuring granule degradation is suitable for all granulated fertiliser.

A representative sample of fertiliser is placed in a tumbler with steel balls and the effect on the sample is determined (refer Fertmark Industry Agreed Methods February 2015 method 2.14).

If a series of different products are to be tested in sequence it is preferable to test the most robust material first. eg. Test TSP before super and super before serpentine.

It may be necessary to wash and dry the mill and ball bearings between samples if there is significant build-up of fines.

The weight of the stainless steel balls should be checked periodically as they wear away with use.

The apparatus used includes:
sieves: 5.6 mm, 1.4 mm, 1.0 mm, pan
2×plastic sample pots
2-place balance
GD ball mill
50×8 mm diameter stainless steel ball-bearings weighing 100±5 g.

The procedure is described as follows:
Sub sampling.
Riffle fertiliser sample down to approximately 500 g.
Sieve this sub-sample roughly between a 5.6 mm and 1.4 mm sieve and retain the >1.4 mm fraction.
Riffle the >1.4 mm fraction further and collect a 60-70 g sub sample and an 80-90 g sub sample for testing.
Sieve these two sub samples again to remove any material <1.4 mm.
Weigh the two sub samples and record the weights to the nearest 0.01 g (W1).

When testing the bung should be in the attachment opening then transfer the weighed sub sample to the GD mill with the 50×8 mm stainless steel balls, attach the cover and screw down firmly. The bung is then removed and slide the mill onto the end over end mixer and tighten the holding screw. Start the mixer and set the timer for 5 min. After 5 min tumbling, remove the mill and replace the rubber bung. Tare the 1 mm sieve then assemble as follows: 5.6 mm (top), 1 mm then pan. Brush the contents of the mill onto the 5.6 sieve and shake gently to ensure all the intact granules have passed through onto the 1 mm sieve. Remove the 1 mm sieve and reweigh, recording the weight of the retained material to the nearest 0.01 g (W2). Brush the ball bearings to remove excess dust then return to the mill and repeat the process for the second sub sample.

Calculate the granule degradation (% GD) based on 75 g sample. Or to calculate manually:

Calculate % GD for each sub sample=(W1_W2)×100

Then plot % GD vs sample weight on linear graph paper and interpolate for 75 g sample.

The results are reported as % GD to the nearest 0.1%

In some embodiments the superphosphate is mixed with the reverting agents for 20, 30, 40, 50, 60, 70, 80, 90, 100, 110 or 120 seconds, and suitable ranges may be selected from between any of these values

### 2. EXAMPLES

### Example 1: Traditional SSP Process

Single superphosphate (SSP) is manufactured by reacting insoluble phosphate rock with sulphuric acid to form a mixture of soluble MCP which is able to be used by plants and CaSO₄.

The composition of the phosphate rock depends upon where it is sourced from, varying in its phosphate, fluoride and silica content.

A total phosphorus content of 15% P by weight is achieved, in some cases by mixing different phosphate sourced rocks. The phosphate rock is reduced to a particle size of about 0.5 cm or less by, for example, passing the phosphate rock through a hammer mill. The coarsely ground rock is ground further to attain a rock grist of approximately 85% less than 75 μm by, for example, passing it through a roller mill (Bradley BM 20).

The powdered rock and sulphuric acid are reacted in a horizontal mixer at a feed rate of 35 tonnes/hr of phosphate rock and about 20.3 to about 21.3 tonnes/hr of 98.5% sulphuric acid and 10.6 tonnes/hr of dilution liquids. The mixture is passed into a Broadfield Den for maturing of the composition (i.e. for the reaction between the phosphate rock and the sulphuric acid to occur). The partially matured superphosphate cake is cut out of the den after 30 minutes retention in the Den.

The mixture is then passed to a granulator which agglomerates the superphosphate to form granules. Following agglomeration the superphosphate is cured for 1-2 weeks and the product screened for oversized granules before dispatch.

SSP made through this process has a total phosphorus content of about 9% P by weight and at least about 85% of the total phosphorus is soluble in 2% weight by volume citric acid.

### Example 2: Process of the Present Invention

The present invention provides a ratio of calcium-source reverting agent to magnesium-source reverting agent at about 38:62. The present invention involves combining a blend of reverting agents to partially matured superphosphate and granulating.

The ratio of magnesium-source reverting agent to calcium-source reverting agent impacts the final product chemical and physical quality. Increasing total volume of reverting agent reduces total P levels and degrades physical quality while improving reversion to citric soluble phosphate. In addition magnesium-source reverting agent aids in the formation of chemical bonds during granulation improving physical quality outcomes.

The reverting agent combination, as mentioned earlier achieves a ratio of aCa:tP that improves reversion to phosphorus soluble in 2% weight by volume citric acid without negatively impacting the final product quality by reversion to insoluble forms of calcium phosphates.

Thus the granulated cured reverted product is improved through a minimised loss of total phosphorus content compared with SSP yet with higher degree of consistency, providing strong granules compared with dialectic superphosphates available on the market. Moreover, the granules of the present invention provide a source of P (dicalcium phosphate) that is insoluble in water and is thus not washed from pasture following rain events.

1. A method of manufacturing phosphate fertilizer that comprises dicalcium phosphate, the method comprising:
providing milled phosphorus-containing rock having a total phosphorus content of at least about 15% P by weight;
mixing the milled phosphate-containing rock with a mineral acid in a reaction vessel to produce a superphosphate product; and
mixing the superphosphate product with a calcium-source reverting agent and a magnesium-source reverting agent to produce a reverted product, the calcium-source reverting agent comprising at least about 20 to about 50% by weight of the total amount of reverting agent of calcium oxide with a calcium carbonate equivalence of at least about 134%, and the magnesium-source reverting agent providing a magnesium source and comprising at least about 50 to about 80% by weight of the total amount of reverting agent of magnesium source with a calcium carbonate equivalence of at least about 80%, to produce a granulated cured reverted product having a product yield of at least about 1.9.

2. A method of manufacturing phosphate fertilizer that comprises dicalcium phosphate, the method comprising:
providing milled phosphorus-containing rock having a total phosphorus content of at least about 14.2% P by weight;
mixing the milled phosphate-containing rock with a mineral acid in a reaction vessel to produce a superphosphate product; and
mixing the superphosphate product with a calcium-source reverting agent and a magnesium-source reverting agent to produce a reverted product, the calcium-source reverting agent comprising at least about 20 to about 50% by weight of the total amount of reverting agent of calcium oxide with a calcium carbonate equivalence of at least about 134%, and the magnesium-source reverting agent providing a magnesium source and comprising at least about 50 to about 80% by weight of the total amount of reverting agent of magnesium source with a calcium carbonate equivalence of at least about 80%, to produce a granulated cured reverted product having a product yield of at least about 1.77 and a moisture content of less than 3%.

3. A method of manufacturing phosphate fertilizer comprising dicalcium phosphate, the method comprising:
providing milled phosphate-containing rock;
mixing the milled phosphate-containing rock with a mineral add in a reaction vessel to produce a superphosphate product; and
mixing the superphosphate product with a calcium-source reverting agent and a magnesium-source reverting agent to produce a reverted product, the calcium-source reverting agent comprising at least about 20 to about 50% by weight of the total amount of reverting agent of calcium oxide with a calcium carbonate equivalence of at least about 134%, and the magnesium-source reverting agent providing a magnesium source and comprising at least about 50 to about 80% by weight of the total amount of reverting agent of magnesium source with a calcium carbonate equivalence of at least about 80%, to produce a granulated cured reverted product having a total phosphorus content of at least about 7.5% P by weight.

4. The method of claim 1, wherein the reverted product is granulated and cured to produce a granulated cured reverted product.

5. The method of claim 4, wherein the granulated cured reverted product is cured for about 14 days.

6. The method of claim 1, wherein the calcium-source reverting agent is selected from calcium oxide, or calcium hydroxide, or a combination thereof.

7. The method of claim 1, wherein the magnesium-source reverting agent is selected from magnesium silicate rocks or magnesium oxide, or a combination thereof.

8. The method of claim 7 wherein the magnesium silicate rocks are selected from dunite or serpentine rock or a combination thereof.

9. The method of claim 1, wherein the product yield is between about 1.77 to about 1.96.

10. The method of claim 1, wherein the weight ratio of the magnesium-source reverting agent to the calcium-source reverting agent is between about 50:50 to about 800:20.

11. The method of claim 1, wherein the calcium-source reverting agent provides about 30% to about 40% by weight of the total weight of the reverting agents.

12. The method of claim 1, wherein the magnesium-source reverting agent provides about 20, 30, 40, 50, 60, 70 or 80% of the total weight of the reverting agents.

13. The method of claim 1, wherein the mixing of the superphosphate product and reverting agents is carried out in a mixer at a temperature of less than about 100° C.

14. The method of claim 1, wherein the reverted product has a molar ratio of available calcium (aCa) to total phosphorus (tP) of about 0 90 to about 1.10.

15. The method of claim 1, wherein the reverted product has a pH of about 3.0 to about 5.0.

16. The method of claim 1, wherein the reverted product has a total phosphorus content of at least about 7 5 to about 8.5% P by weight.

17. The method of claim 1, wherein the granulated cured reverted product is produced by a granulation process that is carried out at a temperature of less than about 100° C.

18. The method of claim 1, wherein the granulated cured reverted product has a total phosphorus content of at least about 7.5 to about 8 5% P by weight.

19. The method of claim 1, wherein at least about 70% of the total phosphorus in granulated cured reverted product is soluble in 2% weight by volume citric acid.

20. The method of claim 1, wherein less than about 20, 21, 22, 23, 24 or 25% of the total phosphorus in the granulated cured reverted product is soluble in water.

21. The method of claim 1, wherein the granulated cured reverted product has a pH of about 4.4 to about 6.0.

22. The method of claim 1, wherein the granulated cured reverted product has a moisture content of about 3 to about 10% H₂O by weight.

23. The method of claim 1, wherein the granulated cured reverted product has a calcium content of about 22 to about 24% Ca by weight.

24. The method of claim 1, wherein the granulated cured reverted product has a sulphate sulphur content of about 9.8 to about 11.7% S by weight.

25. The method of claim 1, wherein the granulated cured reverted product has a magnesium content of at least about 0.9 to about 2% Mg by weight.

26. The method of claim 1, wherein the granulated cured reverted product has a granule strength of at least about 20 to about 25 N.

27. The method of claim 1, wherein the granulated cured reverted product has a granule degradation of less than about 10, 9, 8, 7, 6, 5, 4, 3, 2, or 1%.

28. The method of claim 1, wherein the reverted product is cured on a pile.

29. The method of claim 1, wherein during curing the reverted product cools from an initial temperature to a final ambient temperature.

30. The method of claim 29 wherein the initial temperature of the reverted product is about 70, 75, 80, 85, 90, 95 or 100° C.

31. The method of claim 29, wherein the cooling from an initial temperature to a final ambient temperature follows a cooling curve linearity that is characterized by a Pearson correlation coefficient of at least about −0.8.

32. The method of claim 1, wherein the mineral acid is sulphuric acid.

33. A fertilizer product as produced by claim 1.

34. (canceled)
